(19) United States
(12) Patent Application Publication
(10) Pub. No.: US 2024/0386076 A1
(43) Pub. Date: Nov. 21, 2024

(54) OBJECT SIMILARITY DETERMINATION AND RANKING

(71) Applicant: INTERNATIONAL BUSINESS MACHINES CORPORATION, Armonk, NY (US)

(72) Inventors: Khyati Patel, Harrison, NJ (US); Raj Nagesh, New Hill, NC (US); Wyatt Gabriel Clarke, Yonkers, NY (US); Decio Tadeu Correa Filho, White Plains, NY (US); Yuxi Chen, Chappaqua, NY (US)

(21) Appl. No.: 18/320,740

(22) Filed: May 19, 2023

(51) Int. Cl. G06F 18/2415; G06F 11/34

(52) U.S. Cl. CPC G06F 18/2415; G06F 11/3495

(57) ABSTRACT

Object similarity identification and ranking includes identifying multi-feature objects similar to a target object. The identifying is based on a user-specified similarity metric between the target object and each of the multi-feature objects having a value that exceeds a user-specified threshold. One or more weighted performance metrics is determined by weighting each of one or more performance metrics based on a customization input of a user. A gain score is generated for each of the multi-feature objects, each of the gain scores based on the one or more weighted performance metrics and a base score. A recommendation is output, the recommendation based on ranking the multi-feature objects according to the gain score of each multi-feature.

### BACKGROUND

This disclosure relates to identifying objects similar to a target object, and more particularly, generating recommendations regarding the target object based on attributes of similar objects.

Physical and non-physical objects can be represented by computer-processable data structures such as vectors, matrices, and higher-order tensors whose elements correspond to distinct features of an object. Physical objects may include various types of networking systems, electronic devices, computer hardware, and various types of products, for example. Non-physical objects may include, for example, processes, contracts, work projects, and the like.

Knowing the performance of an object whose features are similar to those of another object for which a decision is to be made can guide decision making regarding the latter object. For example, in designing a network, knowing the performance of an existing network having similar features can assist in the designing of the new network. Knowing the performance associated with different work projects performed by different service providers, for example, may help an organization in contracting with a service provider for a new project whose features are similar to those of the prior projects.

### SUMMARY

In one or more embodiments, a method includes identifying, by an object similarity determiner, a plurality of multi-feature objects similar to a target object. The identifying is in response to a user-specified similarity metric between the target object and each of the multi-feature objects having a value that exceeds a user-specified threshold. The method includes determining, by a performance metric customizer, one or more weighted performance metrics by weighting one or more performance metrics based on a customization input of a user. The method includes generating, by a gain score generator, a gain score for each of the plurality of multi-feature objects. Each gain score of each of the multi-feature objects is based on the one or more weighted performance metrics and a base score. The method includes outputting, by a recommender, a recommendation based on ranking of each of the multi-feature objects in accordance with the gain score of each multi-feature object.

The foregoing and other implementations can each optionally include one or more of the following features, alone or in combination. Some example embodiments include all the following features in combination.

In one aspect, determining one or more weighted performance metrics includes assigning a positive or negative directionality to each one or more weighted performance metrics based on a directionality input of the user.

In another aspect, each gain score is presented to a user via a user interface. Each gain score is regenerated based on a user-specified change to one or more weights of the weighted performance metrics, the changing increasing or decreasing one or more weights used for weighting one or more of the performance metrics.

In another aspect, each gain score is presented to the user via the user interface, and the gain score is regenerated in response to the user adding a new performance metric to the one or more performance metrics or eliminating a performance metric.

In another aspect, the base score is computed using a base score metric selected by the user.

In another aspect, a probability distribution of one or more unweighted performance metrics is determined by a machine learning distribution determiner. Initially, a statistical measure is derived from each probability distribution for weighting each unweighted performance metric. One or more weighted performance metrics is determined by adjusting each statistical measure in response to the user customization input and weighting each unweighted performance metric by the corresponding statistical measure as adjusted by the user customization input.

In one or more embodiments, a system includes one or more processors configured to initiate executable operations as described within this disclosure.

In one or more embodiments, a computer program product includes one or more computer-readable storage media and program instructions collectively stored on the one or more computer-readable storage media. The program instructions are executable by a processor to cause the processor to initiate operations as described within this disclosure.

This Summary section is provided merely to introduce certain concepts and not to identify any key or essential features of the claimed subject matter. Other features of the inventive arrangements will be apparent from the accompanying drawings and from the following detailed description.

### BRIEF DESCRIPTION OF THE DRAWINGS

FIG. 1 illustrates an example of a computing environment that is capable of implementing an object similarity determination and ranking (OSDR) framework.

FIG. 2 illustrates an example architecture of executable OSDR framework of FIG. 1.

FIG. 3 illustrates an example method of operation of the OSDR framework of FIGS. 1 and 2.

FIG. 4 illustrates certain operative aspects of the OSDR framework of FIGS. 1 and 2.

FIGS. 5A through 5D illustrate example visual renderings generated on a user interface by the OSDR framework of FIGS. 1 and 2.

FIG. 6 illustrates another example architecture of executable OSDR framework of FIG. 1.

FIG. 7 illustrates an example method of operation of the OSDR framework of FIGS. 1 and 6.

### DETAILED DESCRIPTION

While the disclosure concludes with claims defining novel features, it is believed that the various features described within this disclosure will be better understood from consideration of the description in conjunction with the drawings. The process(es), machine(s), manufacture(s) and any variations thereof described herein are provided for purposes of illustration. Specific structural and functional details described within this disclosure are not to be interpreted as limiting, but merely as a basis for the claims and as a representative basis for teaching one skilled in the art to variously employ the features described in virtually any appropriately detailed structure. Further, the terms and phrases used within this disclosure are not intended to be limiting, but rather to provide an understandable description of the features described.

This disclosure relates to identifying objects similar to a target object, and more particularly, generating recommendations regarding the target object based on attributes of similar objects. Currently, there are few if any machine-intelligent, end-to-end systems that provide interactively customizable machine learning (ML) or other models for determining object similarities and ranking similar objects (e.g., products, processes, contracts). Conventional systems typically implement black-box ML algorithms or logic-based models, many having features that may make managing the systems difficult and time consuming. Such systems may have different data requirements, necessitating manually processing data from multiple sources in accordance with the different requirements. Manually annotating data from multiple sources in accordance with different system requirements for identifying object similarities may create bottlenecks and are often prone to human error. Moreover, standard black-box ML algorithms like clustering, the Technique for Order of Preference by Similarity to Ideal Solution (TOPSIS), and other ready-to-use models are typically not customizable.

In accordance with the inventive arrangements disclosed herein, methods, systems, and computer program products are provided that are capable of identifying similar objects according to customized user specifications and generating recommendations based on attributes of the similar objects. The inventive arrangements described may be used, for example, to identify similarities between contracts, deals, or commercial opportunities, as well as between physical objects, such as systems, processes, and products. Similar objects may be ranked, and recommendations generated based on specific attributes of the ranked objects.

The inventive arrangements implement a machine-based model. In contrast to black box artificial intelligence (AI) models and logic-based manual models, the machine-implemented model disclosed herein is customizable in accordance with user specifications. User specifications can incorporate different types of metrics to identify certain aspects in a search for similar objects. Customization of the model with user specifications optimizes the likelihood that certain desired features of objects are identified and used in generating a ranking of the objects.

In one aspect, the model implements a function that incorporates performance metrics as parameters to measure object performance. The parameters can be customized by the user to overweight or underweight the parameters. This aspect makes the function suitable for use in a variety of different contexts.

Further aspects of the inventive arrangements are described below with reference to the figures. For purposes of simplicity and clarity of illustration, elements shown in the figures have not necessarily been drawn to scale. For example, the dimensions of some of the elements may be exaggerated relative to other elements for clarity. Further, where considered appropriate, reference numbers are repeated among the figures to indicate corresponding, analogous, or like features.

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

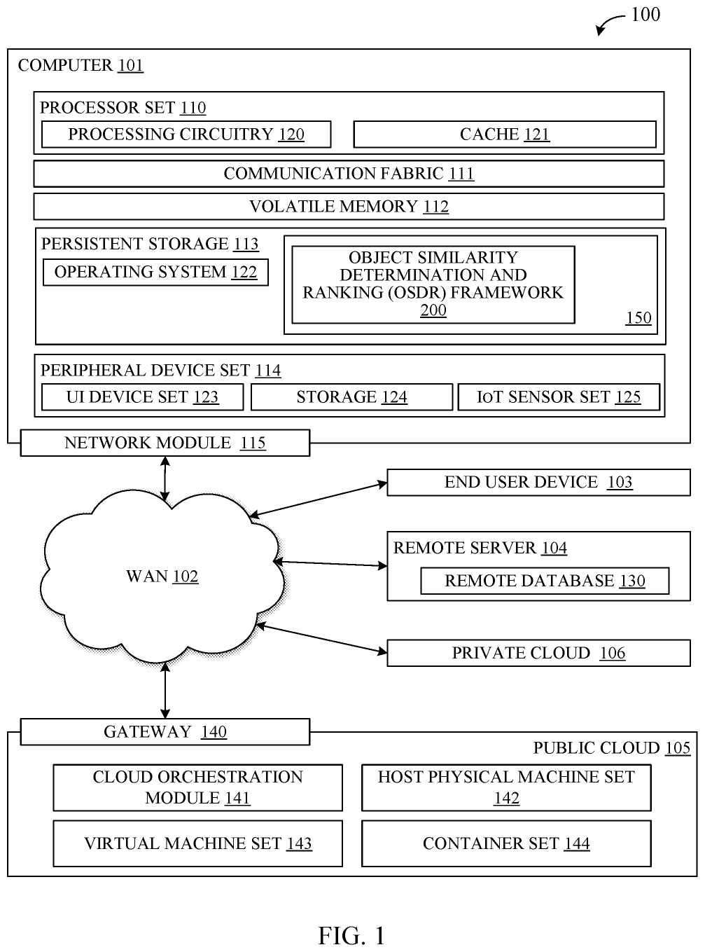

Referring to FIG. 1, computing environment 100 contains an example of an environment for the execution of at least some of the computer code in block 150 involved in performing the inventive methods, such as object similarity determiner and ranker (OSDR) framework 200 implemented as executable program code or instructions. OSDR framework 200 is capable of identifying similar objects and ranking each similar object based on user-specified metrics. The user-specified metrics emphasize certain performance criteria of the objects identified by OSDR framework 200. OSDR framework 200 generates a recommendation using the ranking. The recommendation may specify attributes for implementing a system (e.g., computer system), selecting a product (e.g., computer hardware), devising a work project, or performing some other action. The attributes are ones extracted by OSDR framework 200 from the ranked objects. An action (e.g., system implementation, product selection, process specification) may be formulated using the attributes specified by OSDR framework 200's recommendation so that certain performance metrics associated with the action likely match the user-specified metrics.

Computing environment 100 additionally includes, for example, computer 101, wide area network (WAN) 102, end user device (EUD) 103, remote server 104, public cloud 105, and private cloud 106. In this embodiment, computer 101 includes processor set 110 (including processing circuitry 120 and cache 121), communication fabric 111, volatile memory 112, persistent storage 113 (including operating system 122 and ABC/ML OSDR framework 200, as identified above), peripheral device set 114 (including user interface (UI) device set 123, storage 124, and Internet of Things (IOT) sensor set 125), and network module 115. Remote server 104 includes remote database 130. Public cloud 105 includes gateway 140, cloud orchestration module 141, host physical machine set 142, virtual machine set 143, and container set 144.

Computer 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

Processor set 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

Communication fabric 111 is the signal conduction paths that allow the various components of computer 101 to communicate with each other. Typically, this fabric is made of switches and electrically conductive paths, such as the switches and electrically conductive paths that make up busses, bridges, physical input/output ports and the like. Other types of signal communication paths may be used, such as fiber optic communication paths and/or wireless communication paths.

Volatile memory 112 is any type of volatile memory now known or to be developed in the future. Examples include dynamic type random access memory (RAM) or static type RAM. Typically, the volatile memory is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

Persistent storage 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid-state storage devices. Operating system 122 may take several forms, such as various known proprietary operating systems or open-source Portable Operating System Interface type operating systems that employ a kernel. The code included in block 150 typically includes at least some of the computer code involved in performing the inventive methods.

Peripheral device set 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion type connections (e.g., secure digital (SD) card), connections made though local area communication networks and even connections made through wide area networks such as the internet. In various embodiments, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some embodiments, storage 124 may take the form of a quantum computing storage device for storing data in the form of qubits. In embodiments where computer 101 is required to have a large amount of storage (e.g., where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

Network module 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some embodiments, network control functions and network forwarding functions of network module 115 are performed on the same physical hardware device. In other embodiments (e.g., embodiments that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (e.g., the internet) capable of communicating computer data over non-local distances by any technology for communicating computer data, now known or to be developed in the future. In some embodiments, the WAN may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

End user device (EUD) 103 is any computer system that is used and controlled by an end user (e.g., a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some embodiments, EUD 103 may be a client device, such as thin client, heavy client, mainframe computer, desktop computer and so on.

Remote server 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

Public cloud 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

Private cloud 106 is similar to public cloud 105, except that the computing resources are only available for use by a single enterprise. While private cloud 106 is depicted as being in communication with WAN 102, in other embodiments a private cloud may be disconnected from the internet entirely and only accessible through a local/private network. A hybrid cloud is a composition of multiple clouds of different types (e.g., private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this embodiment, public cloud 105 and private cloud 106 are both part of a larger hybrid cloud.

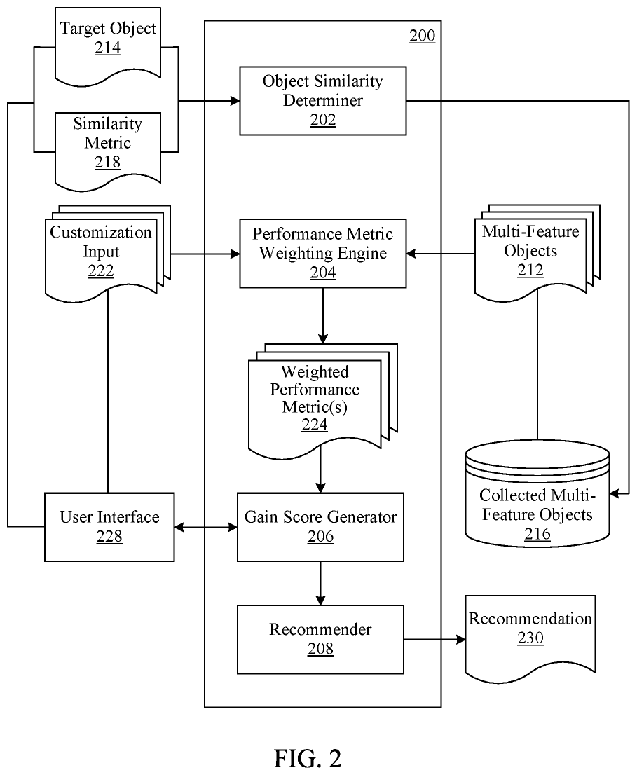

FIG. 2 illustrates an example architecture for the executable OSDR framework 200 of FIG. 1. In the example of FIG. 2, OSDR framework 200 includes object similarity determiner 202, performance metric weighting engine 204, gain score generator 206, and recommender 208.

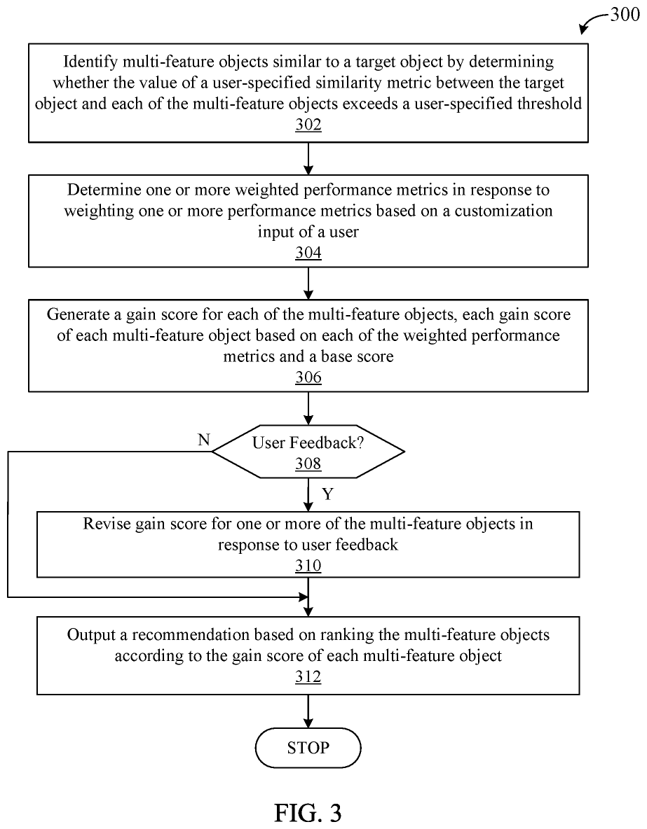

FIG. 3 illustrates an example method 300 of operation of the OSDR framework 200 of FIGS. 1 and 2.

Referring to FIGS. 2 and 3 collectively, in block 302, object similarity determiner 202 identifies multi-feature objects 212 that are similar to target object 214 also having multiple features, specified by user input. Target object 214 is a data structure representing a real-world object. The real-world object can be physical, such as a computing system or hardware, or non-physical, such as a work project or contract. As a data structure, target object 214 may comprise a vector, matrix, or higher-order tensor whose N elements correspond to object features. For example, if target object 214 is a vector representation [symbol] x₁, x₂, . . . , xₙ [symbol] of a computer system (a physical object), then the i-th element xᵢ may represent memory capacity, number of processors, or another component. If, for example, target object 214 is a vector representation of a work project (a non-physical object), then the i-th element xᵢ may represent unit labor cost, number of man hours, or another feature.

Multi-feature objects 212 are data structures of the same type as target object 214. For example, as a vector representation, if yⱼᵢ is the i-th element (i=1, . . . , N) of the j-th multi-feature object (j=1, . . . , M), then yⱼᵢ corresponds to the i-th element xᵢ of target object 214.

Object similarity determiner 202, in certain embodiments, is configured to search collected multi-feature objects 216, a database that electronically stores the data structures including multi-feature objects 212. By comparing features of each multi-feature object stored with those of target object 214, object similarity determiner 202 determines that multi-feature objects 212 are similar to target object 214. Object similarity determiner 202, in certain embodiments, identifies similar objects by determining that the value of similarity metric 218 between target object 214 and each of the multi-feature objects 212 exceeds a user-specified threshold. Similarity metric 218 and a threshold value thereof may both be specified by the user. In some embodiments, similarity metric 218 is the Jaccard index or Jaccard similarity coefficient. Similarity metric 218 in other embodiments is a cosine similarity. In still other embodiments, similarity metric 218 is another metric that measures the similarity between target object 214 and multi-feature objects electronically stored among collected multi-feature objects 216.

In certain interactive embodiments, OSDR framework 200 presents a menu of similarity metrics to the user via user interface 228, from which the user can select a similarity metric. For example, a dropdown list of metrics can be presented to the user by OSDR framework 200 via user interface 228. User interface 228, in certain embodiments, is a graphical user interface (GUI).

In block 304, performance metric weighting engine 204 determines one or more weighted performance metrics 224 by the weighting of one or more performance metrics in accordance with customization input 222 specified by the user via user interface 228. Each of the one or more performance metrics measures a specific aspect of each of multi-feature objects 212's performance. In the context of work projects and contracts, for example, each performance metric can each be a key performance indicator (KPI). For example, if multi-feature objects 212 represent historically captured work projects performed by different service providers, then two example performance metrics for measuring each work project's performance are a gross profit KPI and a contract completion time KPI. In the context of a system such as a computer system, for example, performance metric(s) can include data throughput, energy consumption, or other measures of performance.

If only a single performance metric is associated with each of multi-feature objects 212, then the performance metric(s) may be a scalar. If multiple performance metrics are associated with each of multi-feature objects 212, then performance metric(s) may comprise a data structure such as a vector. The vector or scalar can be concatenated with the data structure representing the features of multi-feature objects 212. In certain interactive embodiments, OSDR framework 200 prompts the user (e.g., via a GUI) to specify customization input 222, based on which performance weighting engine 204 computes individual weights applied to one or more performance metrics associated with each of multi-feature objects 212.

Weighted performance metric(s) 224 are generated by performance metric weighting engine 204 applying each weight (e.g., multiplicative term or coefficient) to each corresponding one or more performance metrics. The weights, based on customization input 222 specified by the user, reflect the relative importance of each performance metric for the specific user of OSDR framework 200. Customization input 222 enables each individual unit to customize the output of OSDR framework 200 by weighting different performance metrices differently depending on the relative importance of each aspect to the specific user. For example, in the context of assessing a computer system or hardware data throughput may be more important than energy consumption for one user, while for another user, energy consumption may be the more important aspect. Customization input 222 enables each user to customize the output of OSDR framework 200 to reflect the relative importance of each performance metric to each specific user. This contrasts with conventional machine learning models that are not customizable according to user specifications. As described more fully below, customization input 222 can specify a magnitude and/or a directionality for weighting each performance metric according user specification.

In block 306, gain score generator 206 generates a gain score for each of multi-feature objects 212. Each gain score is a function of weighted performance metric(s) 224 and a base score. The function is described by the right-hand side of the following equation:

$$GS = α * \frac{{\sum }_{k = 1}^{n} ( t [ k ] * f [ k ] )}{{\sum }_{k = 1}^{n} {t [ k ]}^{2} + {\sum }_{k = 1}^{n} {f [ k ]}^{2} - {\sum }_{k = 1}^{n} ( t [ k ] * f [ k ] )} + {\sum }_{i}^{m} d [ i ] * β [ i ] * \frac{PM [ i ] - min ( PM [ i ] )}{max ( PM [ i ] ) - min ( PM [ i ] )} \qquad EQ . 1$$

where α=(1−Σᵢ₌₁^{m}β[i])>0; t[k] and f[k] are the k-th feature of target object 214 and of each of multi-feature objects 212, respectively; β[i] is the weight applied to the i-th performance metric PM[i]; and d[i] is a directionality coefficient applied to the i-the performance metric. Both β[i] and d[i], for i=1, . . . , m, may be specified by the user through customization input 222, where m is the number of performance metrics PM[i] associated with each of multi-feature objects 212.

The first term on the right-hand side of equation EQ. 1 is an alpha-scaled base score, whose value depends on the interaction between each feature of target object 214 and the same feature of each object among multi-feature objects 212. Illustratively, the first term is a base score that comprises a ratio of sums of the features of multi-feature objects 212 and target object 214.

The term measures the base similarity between multi-feature objects 212 and target object 214 according to the similarity of individual features, irrespective of performance metrics. The base similarity, in various embodiments, can be computed using different base score metrics for computing the base score. The user can specify the base score as part of customization input 222 input via user interface 228. The base score metric can be cosine similarity, Jaccard similarity, or other metrics for determining the base similarity apart from the performance metrics.

The base similarity is scaled by the alpha term, subject to the constraint α=(1−Σᵢ₌₁^{m}β[i])>0. Intuitively, alpha provides a residual with respect to the base similarity given the beta-weighted performance metrics. Gain score generator 206 automatically adjusts the user-specified weights to ensure that alpha plus the betas equals one. Automatically, gain score generator 206 computes the weights subject to the constraint that the summation of the weights is less than one. In default mode, if the user does not specify the weights, then gain score generator 206 allocates fifty percent of the weighting to alpha and distributes the remainder evenly among each of the betas to ensure the above-indicated constraint is satisfied.

Each directionality coefficient d[i] may be supplied by the user through customization input 222. A directionality coefficient d[i] indicates whether the gain score increases or decreases as the performance metric increases (e.g., first derivative with respect to the performance metric). The directionality coefficient is one if the gain score increases as the performance metric increases or negative one if the gain score decreases as the performance metric increases. For example, in the context of a work project having the performance metrics of gross profit KPI and contract completion time KPI, the gain score increases with greater gross profit but decreases as the time to completion increases.

Each of performance metric(s) PM[i] appearing as part of the second term of the right-hand side of EQ. 1 is scaled. Performance metric(s) PM[i] are scaled in accordance with the following equation, thereby ensuring that each scaled value is between zero and one:

$$Scaled performance metric ( PM ) = \frac{PM [ i ] - min ( PM [ i ] )}{max ( PM [ i ] ) - min ( PM [ i ] )} . \qquad EQ . 2$$

In block 308, OSDR framework 200 implements a type of feedback loop with which the user is able to input data via user interface 228 to modify or adjust the individual terms of EQ. 1. OSDR framework 200 presents each gain score to the user via user interface 228. The user is thus able to view and consider the gain scores. If the user desires, the user may refine the gain scores by adjusting up or down one or more of the β[i]'s (multiplicative weights) applied to the i-th performance metric(s) PM[i] of multi-feature objects 212. A user-specified change to one or more of the β[i]'s changes one or more corresponding weighted performance metric(s) 224 accordingly. Gain score generator 206 in response to the user-specified change to one or more of the β[i]'s regenerates the gain score for each of multi-feature objects 212 based on at least one user-specified change to one or more weighted performance metric(s) 224. The user also may eliminate one or more of performance metric(s) 224. Performance metric weighting engine 204 generates and applies a weight (e.g., multiplicative term or coefficient) to each newly added performance metric. Gain score generator 206 regenerates the gain scores in response to the user adding a new performance metric to the one or more performance metrics or eliminating a performance metric.

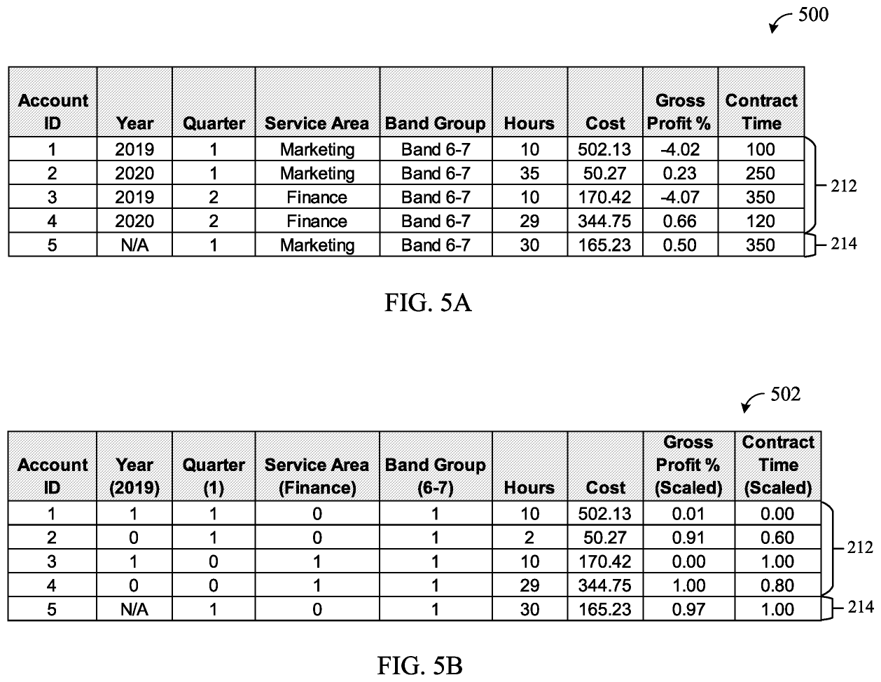

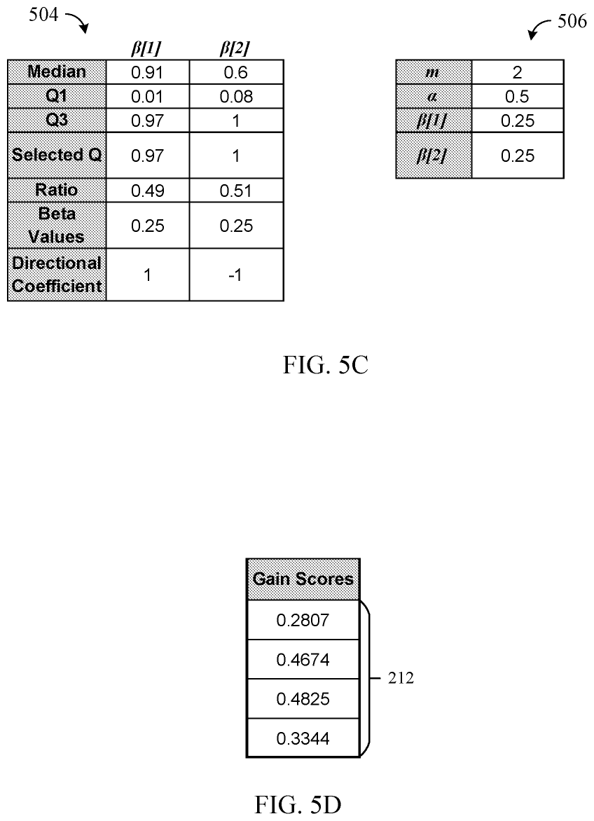

In certain embodiments, OSDR framework 200 generates a display on user interface 228 (e.g., GUI) showing the values of features of multi-feature objects 212 and target object 214 concatenated with each performance metric(s) PM[i], along with the gain scores of multi-feature objects 212 (FIGS. 5A-5D). Via user interface 228, OSDR framework 200 enables the user to adjust weights applied to one or more of performance metric(s) PM[i]. For example, a user may increase weight β[i], applied to the i-th performance metric PM[i], by some percentage and/or decrease weight β[j], applied to the j-th performance metric (PM), by some percent. OSDR framework 200 recomputes the gain score in response to the user's changing one or more weights applied to performance metric(s) PM[i]. In some embodiments, OSDR framework 200, via user interface 228, enables the user to add one or more new performance metrics or remove one or more performance metrics. OSDR framework 200 recomputes the gain score in response to the user's adding one or more new performance metrics and/or the user's eliminating one or more of performance metric(s) PM[i].

Each gain score quantitatively measures the similarity between each of multi-feature objects 212 and target object 214. Unlike conventional similarity metrics (e.g., cosine similarity), however, each gain score incorporates weighted performance metric(s) 224. Thus, each gain score also quantitively measures the importance of each object's performance on one or more dimensions. The relative importance of different performance metrics is a customizable aspect of OSDR framework 200. Performance metric(s) PM[i], as specified by the user, may lead to a higher gain score for one of multi-feature objects 212 than for another even though the latter is more similar to target object 214 according to conventional similarity metrics.

For example, two different users seeking a computing system replacement may look for guidance to objects whose features are similar to that of the target object. The target and multi-feature objects representing different computing systems may be similar in terms of features such as number of processors, memory size, and the like. One of the two users may input performance metrics that emphasize processing capability (e.g., data throughput), whereas the other may input performance metrics that emphasize reliability (e.g., number of system failures per unit time). Given the close similarity in features of the multi-feature objects, conventional techniques generate the same similarity score for both users given the same set of multi-feature objects. OSCR framework 200, however, generates different gain scores for the same set of multi-feature objects based on the different weights for weighting each of the performance metrics, as specified by the two different users. Moreover, because multiple performance metrics may be specified by the user, each weighted by relative importance, the gain scores may be based on a mix of different performance metrics, some of which may have positive directionality and some of which may have negative directionality. This is one of the capabilities that enables OSDR framework 200 to generate customized recommendations for different users.

In block 310, gain score generator 206 may revise one or more gain scores of multi-feature projects 212 in response to user feedback input via user interface 228. If the user provides no feedback, or if the user is satisfied that no additional feedback is needed, then gain score generator 206 generates a final set of gain scores. The gain scores are used by recommender 208 to generate a recommendation.

In block 312, recommender 208 outputs recommendation 230. Recommendation 230 may be based on ranking the multi-feature objects according to the gain score of each of multi-feature objects 212. Recommender 208 can select the top-ranked multi-feature object and generate recommendation 230 based on the specific features of the top-ranked multi-feature object. Given the ranking of multi-feature objects 212 is customized according to the specific performance metrics specified by a user, recommendation 210 by recommender 208 is likewise customized to the specific user. Rankings of the same multi-feature objects may differ according to the user-specified performance metrics. For example, in the above-described example of selecting a computer system, the recommendations generated for the different users will be different. Although each performance metric of the multi-feature objects is the same, different performance metrics may be more important for different users. Rankings of the multi-feature objects will differ according to the different emphases each user places on different performance metrics. One recommendation may recommend a system whose features (e.g., those of the highest-ranked object) are associated with high data throughput. The other recommendation may recommend a system whose features (e.g., those of a different object that is ranked highest) are associated with system reliability.

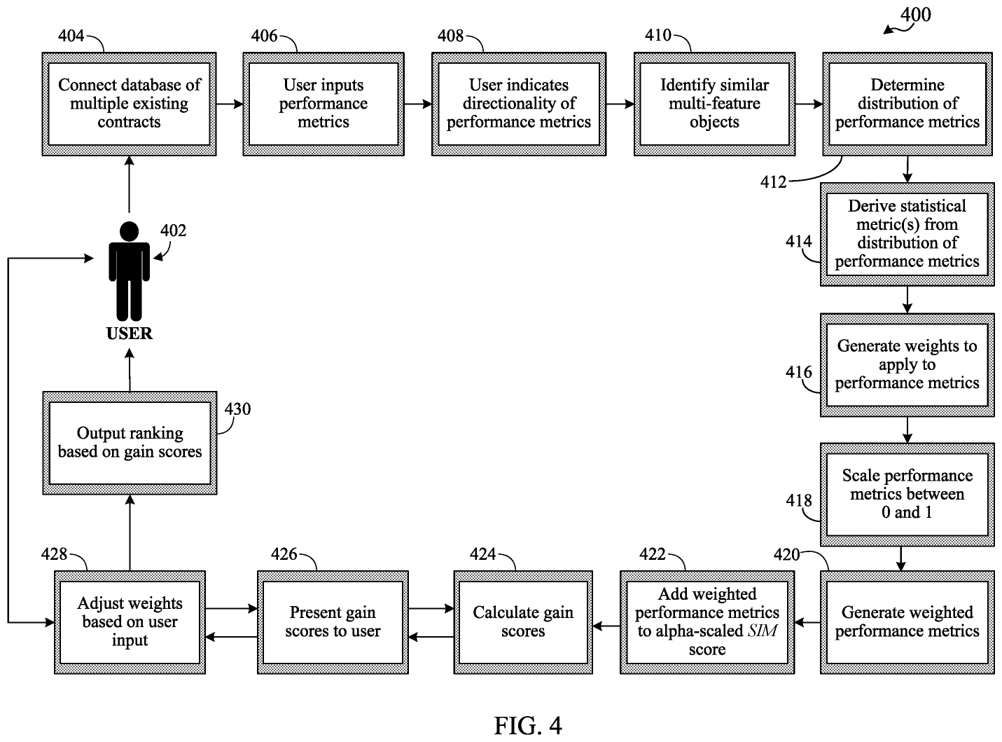

Although thus far described primarily in terms of multi-feature objects that are physical, OSDR framework 200 is also capable of generating recommendations regarding non-physical multi-feature objects, as illustrated in FIG. 4.

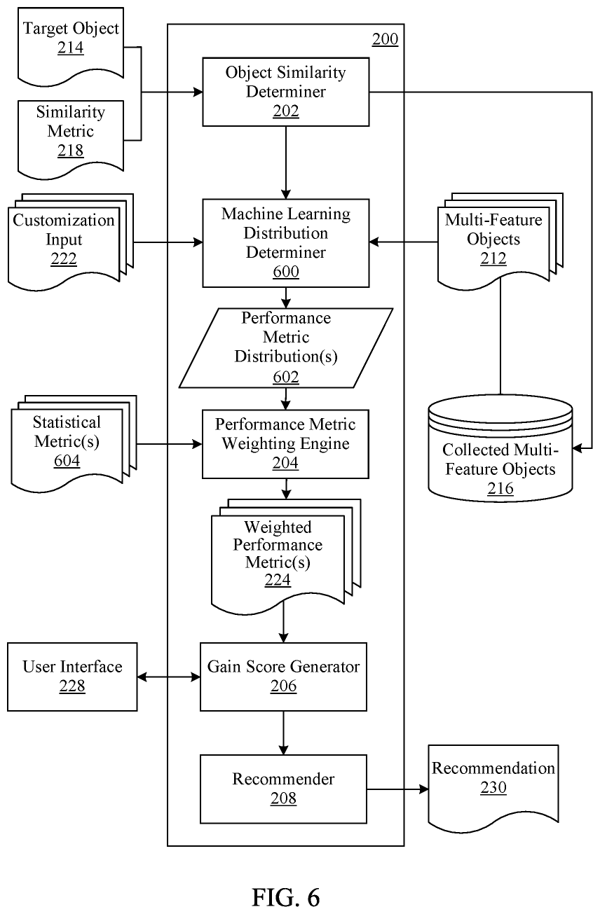

FIG. 4 illustrates certain operative aspects 400 of OSDR framework 200 in the context of contracting with a service provider for a work project. Initially, in block 404, user 402 connects with a database comprising collected multi-feature objects 216. In the present context, the multi-feature objects electronically stored therein include multi-feature objects 212, which are ones representing contracts concluded in the past for other work projects from past years (e.g., 2019 and 2020). Target object 214 is a current, future, or hypothetical contract which is analyzed by comparison with those from past years. In block 406, user 402 inputs performance metric(s) PM[i] that are important considerations in the present context. User 402, in block 408, inputs data indicating the directionality of performance metric(s). The data is used by performance metric weighing engine 206 to generate directionality coefficients, each being either positive one or negative depending on whether or not the particular performance metric is desirable. In block 410, object similarity determiner 202 determines multi-feature objects 212 based on their similarity to user-specified target object 214. Similarity is determined by object similarity determiner 202 based on a Jaccard index, cosine similarity, or other similarity metric. In block 412, a machine learning distribution determiner, as described below, determines a distribution (e.g., probability density function) of each of performance metric(s) PM[i]. Performance metric weighting engine 204, in block 414, derives statistical metrics (e.g., quartiles, means, standard deviations) from the performance metrics distributions determined by machine learning distribution determiner (FIG. 6).

In block 416, performance metric weight engine 206 generates weights for weighting performance metric(s) based on statical metrics derived from their distributions. Performance metric weighting engine 204, in block 418, scales performance metric(s). In block 420, performance metric weight engine 206 generates weighted performance metric(s) 224 by multiplying each of the scaled performance metrics by its respective weight. In block 422, gain score generator 206 adds weighted performance metric(s) 224 to an alpha-scaled similarity score. Gain score generator 206, in block 424, calculates gain scores for each of multi-feature objects 212. The gain scores are calculated using the GS equation, above. In the present context of contracting with a service provider for a work project, EQ. 1 takes the following form:

$$α * \frac{{\sum }_{k = 1}^{n} ( t [ k ] * h [ k ] )}{{\sum }_{k = 1}^{n} t [ k ] \hat{} 2 + {\sum }_{k = 1}^{n} h [ k ] \hat{} 2 - {\sum }_{k = 1}^{n} ( t [ k ] * h [ k ] )} + β [ 1 ] * \frac{tGP - min ( GP )}{max ( GP ) - min ( GP )} - β [ 2 ] * \frac{tCT - min ( CT )}{max ( CT ) - min ( CT )}$$

comprising two performance metrics, namely a KPI for gross profit (GP) and a KPI for contract time (CT) for completing the work project.

In block 426, visual renderings are presented to user 402 via user interface 228. Referring additionally to FIGS. 5A through 5D, example visual renderings are illustrated. Display 500 of FIG. 5A shows raw data in which the first four rows correspond to multi-feature objects 212 and the fifth row corresponds to target object 214 with respect to which the similarity of the four multi-feature objects 212 is determined. Columns one through seven are features of multi-feature objects 212 and target object 214. Performance metrics, namely the gross profit KPI (GP) and contract time KPI (CT), are concatenated with the features in the last two columns, respectively. In display 502 of FIG. 5B, the categorical data of display 500 (features in columns one through five) are converted to quantitative data though one-hot encoding. Display 504 of FIG. 5C shows statistical metric(s) 604 derived by performance metric weighting engine 204 from the distribution of each performance metric. β[1] (second column) and β[2] (third column). The statistics include the median (first row), first and third quartiles (second and third rows), the Q values, (fourth row), and ratio (fifth row) of performance metrics β[1] and β[2]. The values of performance metrics β[1] and β[2] (sixth row) are both 0.25. Directionality coefficients (last row) of performance metrics β[1] and β[2] are one and minus one, respectively, indicating that the gain score increases with an increase in gross profit but decreases with an increase in contract time. Display 506 of FIG. 5C indicates the number of performance metrics, m=2, the alpha valuc, α= (1−0.25−0.25)=0.5, and repeats the values of performance metrics β[1] and β[2].

Display 508 of FIG. 5D shows the gain scores of multi-feature objects 212. The gain scores reflect the relative importance that the individual user places on each performance metric and thus determine the recommendation 230 output to the user by recommender 208.

Recommendation 230 depends on the ranking determined by each gain score of each multi-feature object, and the gain scores depend on the user-specification of emphasis on the respective performance metrics.

Referring still to FIG. 4, in block 428, user 402 may optionally change β[1] and/or β[2], eliminate one of the performance metrics (gross profit KPI or contract time KPI), and/or add other performance metrics. In response to an optional adjustment by user 402, gain score generator redetermines the gain scores of each of multi-feature objects 212. The feedback loop of user modification and gain score redetermination may iteratively repeat until user 402 has made all changes deemed necessary. Note that user 402 is able to customize the model (EQ. 1) by changing the weights applied to the gross profit KPI (GP) and/or contract time KPI (CT). That is, by modifying the weights, user the user can emphasize one KPI over the other. User 402 is able to emphasize gross profit over contract time or vice versa, for example. The rankings of the different multi-feature objects 212 will change accordingly. Thus, user 402 is able to identify the best example among multi-feature objects 212 according to which performance indicators user 402 deems more important. Selecting the best example based on the ranking can provide user 402 with guidance in making decisions regarding contracting for a new work project.

In general, OSDR framework 200 implements an unsupervised approach that obviates the need for model training or supervised machine learning. The feedback loop for user modification, available for execution in block 428, nonetheless enables the user to iteratively refine the unsupervised implementation with quantitative input in the form of weight adjustments. OSDR framework 200 thus “learns” nuances through the feedback, the learning enabling the generation of scores that reflect individual user emphases in view of the weighting of the individual performance metrics. Iterations of the feedback loop enable OSDR framework 200 to generate more accurate gain scores over time, each successive score more closely aligned with the specific user. For example, in the current context, the initial gain score may not adequately distinguish between the respective performance metrics, gross profit and completion time. Thus, in response to user feedback, OSDR framework 200 may increase the beta of one performance metric and/or decrease the percentage of the other thereby refining the gain scores to accentuate the distinction between the separate performance metrics.

In block 430, in response to a user input indicating no further modifications are forthcoming, recommender 208 outputs recommendation 230 based on ranking multi-feature objects 212 according to the gain score of each multi-feature object. Recommendation 230 may list the features of the highest-ranked multi-feature object that simultaneously optimizes the performance metrics of gross profit and contract time, each which based on the user specification is equally weighted. Recommendation 230 can indicate specific features that the user should specify in contracting with a service provider for the work project.

An alternative embodiment of OSDR framework 200 is illustrated in FIG. 6. In FIG. 6, OSDR framework 200 illustratively includes machine learning distribution determiner 600 in addition to object similarity determiner 202, performance metric weighting engine 204, gain score generator 206, and recommender 208.

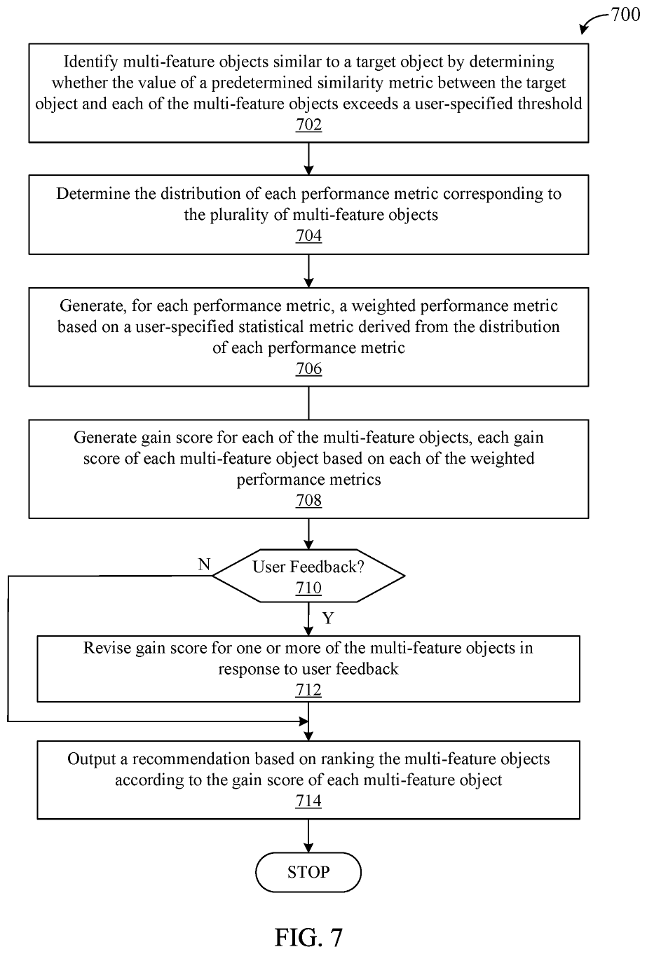

FIG. 7 illustrates example method 700 of operation of the OSDR framework 200 of FIGS. 1 and 6.

Referring to FIGS. 6 and 7 collectively, in block 702, object similarity determiner 202 identifies multi-feature objects 212 that are similar to target object 214 also having multiple features, specified by user input.

In block 704, machine learning distribution determiner 600 determines one or more performance metric distributions 602. Each performance metric distribution corresponds to one or more performance metrics associated with each of multi-feature objects 212.

Machine learning distribution determiner 600 determines performance metric distribution(s) by performing a density estimation for each performance metric associated with each of multi-feature objects 212. The density estimation is an estimation of an underlying probability distribution of each performance metric. In certain embodiments, machine learning distribution determiner 600 implements a machine learning model trained using unsupervised learning to estimate a probability density function for each of performance metric(s). The machine learning model, in some embodiments, can implement non-parametric methods to determine a distribution such as a histogram. In other embodiments, the machine learning distribution determiner 600 can implement parametric methods to determine one or more parameters (e.g., mean, standard deviation) of a specific distribution specified by the user (e.g., via a GUI) for one or more of performance metric(s). Machine learning distribution determiner 600 is capable of determining the underlying probability distributions of performance metric(s) based on user-selected data inputs, the data inputs comprising past or historical performance metrics related to a specific type of problem. As described above, the specific types of problem include implementing a system (e.g., computer system), selecting a product (e.g., computer hardware), devising a work project, or performing some other action.

In block 706, performance metric weighting engine 204 generates one or more weighted performance metrics 224 for each of the performance metric(s) associated with each of multi-feature objects 212. Performance metric weighting engine 204 weights each performance metric by a weight corresponding to one or more statistical metrics 604 that are derived by performance metric weighting engine 204 from the distribution of each performance metric, the distribution determined by machine learning distribution determiner 600. For example, a weight for weighting one of performance metric(s) can correspond to a quartile (e.g., third quartile) of the performance metric. Statistical metric(s) 604 can be specified by the user. In certain embodiments, OSDR framework 200 prompts the user (e.g., via a GUI) to specify one or more statistical metric(s) 604 for each of performance metric(s). Performance metric weighting engine 204 derives the specified statistical metric(s) 604 from the corresponding distributions and generates weights for weighting performance metric(s) accordingly.

In block 708, gain score 208 generator, as previously described, generates a gain score for each of the multi-feature objects. Each gain score of each multi-feature object is based on a corresponding one of weighted performance metric(s) 224.

In block 710, the gain scores generated in block 708 are presented to the user via user interface 228 (e.g., GUI) as also previously described, enabling the user to provide feedback.

In block 712, as previously described, gain score generator 206 revises one or more gain scores of multi-feature projects 212 in response to receiving user feedback input in block 710. If the user provides no feedback, or if the user is satisfied that no additional feedback is needed, then gain score generator 206 generates a final set of gain scores. The gain scores are used by recommender 208 to generate a recommendation.

In block 714, recommender 208 outputs recommendation 230. Recommendation 230 may be based on ranking the multi-feature objects according to the gain score of each of multi-feature objects 212. Recommender 208 can select the top-ranked multi-feature object and generate recommendation 230 based on the specific features of the top-ranked multi-feature object.

The terminology used herein is for the purpose of describing particular embodiments only and is not intended to be limiting. Notwithstanding, several definitions that apply throughout this document will now be presented.

As defined herein, the term “approximately” means nearly correct or exact, close in value or amount but not precise. For example, the term “approximately” may mean that the recited characteristic, parameter, or value is within a predetermined amount of the exact characteristic, parameter, or value.

As defined herein, the terms “at least one,” “one or more,” and “and/or,” are open-ended expressions that are both conjunctive and disjunctive in operation unless explicitly stated otherwise. For example, each of the expressions “at least one of A, B and C.” “at least one of A, B, or C,” “one or more of A, B, and C,” “one or more of A, B, or C,” and “A, B, and/or C” means A alone, B alone, C alone, A and B together, A and C together, B and C together, or A, B and C together.

As defined herein, the term “automatically” means without user intervention.

As defined herein, the terms “includes.” “including.” “comprises,” and/or “comprising.” specify the presence of stated features, integers, steps, operations, elements, and/or components, but do not preclude the presence or addition of one or more other features, integers, steps, operations, elements, components, and/or groups thereof.

As defined herein, the term “if” means “when” or “upon” or “in response to” or “responsive to,” depending upon the context. Thus, the phrase “if it is determined” or “if[a stated condition or event] is detected” may be construed to mean “upon determining” or “in response to determining” or “upon detecting[the stated condition or event]” or “in response to detecting[the stated condition or event]” or “responsive to detecting[the stated condition or event]” depending on the context.

As defined herein, the terms “one embodiment,” “an embodiment,” “in one or more embodiments,” “in particular embodiments,” or similar language mean that a particular feature, structure, or characteristic described in connection with the embodiment is included in at least one embodiment described within this disclosure. Thus, appearances of the aforementioned phrases and/or similar language throughout this disclosure may, but do not necessarily, all refer to the same embodiment.

As defined herein, the term “output” means storing in physical memory elements, e.g., devices, writing to display or other peripheral output device, sending or transmitting to another system, exporting, or the like.

As defined herein, the term “processor” means at least one hardware circuit configured to carry out instructions. The instructions may be contained in program code. The hardware circuit may be an integrated circuit. Examples of a processor include, but are not limited to, a central processing unit (CPU), an array processor, a vector processor, a digital signal processor (DSP), a field-programmable gate array (FPGA), a programmable logic array (PLA), an application specific integrated circuit (ASIC), programmable logic circuitry, and a controller.

As defined herein, “real time” means a level of processing responsiveness that a user or system senses as sufficiently immediate for a particular process or determination to be made, or that enables the processor to keep up with some external process.

As defined herein, the term “responsive to” means responding or reacting readily to an action or event. Thus, if a second action is performed “responsive to” a first action, there is a causal relationship between an occurrence of the first action and an occurrence of the second action. The term “responsive to” indicates the causal relationship.

As defined herein, the term “substantially” means that the recited characteristic, parameter, or value need not be achieved exactly, but that deviations or variations, including for example, tolerances, measurement error, measurement accuracy limitations, and other factors known to those of skill in the art, may occur in amounts that do not preclude the effect the characteristic was intended to provide.

As defined herein, the term “user” refers to a human being.

The terms “first.” “second,” etc. may be used herein to describe various elements. These elements should not be limited by these terms, as these terms are only used to distinguish one element from another unless stated otherwise or the context clearly indicates otherwise.

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method, comprising:
identifying, by an object similarity determiner, a plurality of multi-feature objects similar to a target object, wherein the identifying is responsive to a user-specified similarity metric between the target object and each of the multi-feature objects having a value that exceeds a user-specified threshold;
determining, by a performance metric customizer, one or more weighted performance metrics by weighting one or more performance metrics based on a customization input of a user;
generating, by a gain score generator, a gain score for each of the plurality of multi-feature objects, wherein the gain score of each of the plurality of multi-feature objects is based on the one or more weighted performance metrics and a base score; and
outputting, by a recommender, a recommendation based on ranking the plurality of multi-feature objects in accordance with the gain score of each multi-feature object.

2. The computer-implemented method of claim 1, wherein the determining the one or more weighted performance metrics comprises:
assigning a positive or negative directionality to each of the one or more weighted performance metrics based on a directionality input of the user.

3. The computer-implemented method of claim 1, further comprising:
presenting each gain score to a user via a user interface; and
regenerating each gain score based on at least one user-specified change to the one or more weighted performance metrics.

4. The computer-implemented method of claim 1, further comprising:
presenting each gain score to a user via a user interface; and
regenerating each gain score in response to the user adding a new performance metric to the one or more performance metrics or eliminating a performance metric.

5. The computer-implemented method of claim 1, wherein the base score is computed using a base score metric selected by the user.

6. The computer-implemented method of claim 1, wherein the determining comprises:
determining, by a machine learning distribution determiner, a probability distribution of one or more unweighted performance metrics corresponding to the one or more weighted performance metrics and generating for each unweighted performance metric a statistical measure; and
determining the one or more weighted performance metrics by adjusting each statistical measure in response to the user customization input and weighting each unweighted performance metric by a corresponding statistical measure as adjusted by the user customization input.

7. The computer-implemented method of claim 6, wherein the statistical metric is a user-selected quartile.

8. A system, comprising:
one or more processors configured to initiate operations including:
identifying, by an object similarity determiner, a plurality of multi-feature objects similar to a target object, wherein the identifying is responsive to a user-specified similarity metric between the target object and each of the multi-feature objects having a value that exceeds a user-specified threshold;
determining, by a performance metric customizer, one or more weighted performance metrics in response to weighting one or more performance metrics based on a customization input of a user;
generating, by a gain score generator, a gain score for each of the plurality of multi-feature objects, wherein the gain score of each of the plurality of multi-feature objects is based on the one or more weighted performance metrics and a base score; and
outputting, by a recommender, a recommendation based on ranking the plurality of multi-feature objects in accordance with the gain score of each multi-feature object.

9. The system of claim 8, wherein the determining one or more weighted performance metrics includes:
assigning a positive or negative directionality to each of the one or more weighted performance metrics based on a directionality input of the user.

10. The system of claim 8, wherein the one or more processors are configured to initiate operations further including:
presenting each gain score to a user via a user interface; and
regenerating each gain score based on at least one user-specified change to the one or more weighted performance metrics.

11. The system of claim 8, wherein the one or more processors are configured to initiate operations further including:
presenting each gain score to a user via a user interface; and
regenerating each gain score in response to the user adding a new performance metric to the one or more performance metrics or eliminating a performance metric.

12. The system of claim 8, wherein the base score is computed using a base score metric selected by the user.

13. The system of claim 8, wherein the determining comprises:
determining, by a machine learning distribution determiner, a probability distribution of one or more unweighted performance metrics corresponding to the one or more weighted performance metrics and generating for each unweighted performance metric a statistical measure; and
determining the one or more weighted performance metrics by adjusting each statistical measure in response to the user customization input and weighting each unweighted performance metric by a corresponding statistical measure as adjusted by the user customization input.

14. A computer program product, the computer program product comprising:
one or more computer-readable storage media and program instructions collectively stored on the one or more computer-readable storage media, the program instructions executable by a processor to cause the processor to initiate operations including:
identifying, by an object similarity determiner, a plurality of multi-feature objects similar to a target object, wherein the identifying is responsive to a user-specified similarity metric between the target object and each of the multi-feature objects having a value that exceeds a user-specified threshold;
determining, by a performance metric customizer, one or more weighted performance metrics in response to weighting one or more performance metrics based on a customization input of a user;
generating, by a gain score generator, a gain score for each of the plurality of multi-feature objects, wherein the gain score of each of the plurality of multi-feature objects is based on the one or more weighted performance metrics and a base score; and
outputting, by a recommender, a recommendation based on ranking the plurality of multi-feature objects in accordance with the gain score of each multi-feature object.

15. The computer program product of claim 14, wherein the determining one or more weighted performance metrics includes:
assigning a positive or negative directionality to each of the one or more weighted performance metrics based on a directionality input of the user.

16. The computer program product of claim 14, wherein the one or more processors are configured to initiate operations further including:
presenting each gain score to a user via a user interface; and
regenerating each gain score based on at least one user-specified change to the one or more weighted performance metrics.

17. The computer program product of claim 14, wherein the one or more processors are configured to initiate operations further including:
presenting each gain score to a user via a user interface; and
regenerating each gain score in response to the user adding a new performance metric to the one or more performance metrics or eliminating a performance metric.

18. The computer program product of claim 14, wherein the base score is computed using a base score metric selected by the user.

19. The computer program product of claim 14, wherein the determining includes:
determining, by a machine learning distribution determiner, a probability distribution of one or more unweighted performance metrics corresponding to the one or more weighted performance metrics and generating for each unweighted performance metric a statistical measure; and
determining the one or more weighted performance metrics by adjusting each statistical measure in response to the user customization input and weighting each unweighted performance metric by a corresponding statistical measure as adjusted by the user customization input.

20. The computer program product of claim 19, wherein the statistical metric is a user-selected quartile.
